(19) United States
(12) Patent Application Publication
(10) Pub. No.: US 2014/0198705 A1
(43) Pub. Date: Jul. 17, 2014

(54) Orthogonal frequency division multiple access (OFDMA) and duplication signaling within wireless communications

(71) Applicant: BROADCOM CORPORATION, IRVINE, CA (US)

(72) Inventors: Ron Porat, San Diego, CA (US); Nihar Jindal, San Francisco, CA (US)

(73) Assignee: BROADCOM CORPORATION, IRVINE, CA (US)

(21) Appl. No.: 14/041,225

(22) Filed: Sep. 30, 2013

Related U.S. Application Data
(60) Provisional application No. 61/751,401, filed on Jan. 11, 2013.
(60) Provisional application No. 61/831,789, filed on Jun. 6, 2013.
(60) Provisional application No. 61/870,606, filed on Aug. 27, 2013.
(60) Provisional application No. 61/873,512, filed on Sep. 4, 2013.

(51) Int. Cl. H04W 4/06

(52) U.S. Cl. CPC H04W 4/06
USPC 370/312

(57) ABSTRACT

Communications are supported between wireless communication devices using OFDMA signaling and duplicate processing. An OFDMA frame, which includes first data intended for a first recipient device and second data intended for a second recipient device, is transmitted via a first sub-channel, and a duplicate of the OFDMA frame is transmitted via a second sub-channel. In some instances, additional duplicates of the OFDMA frame are transmitted via additional sub-channels. The OFDMA frame may be generated based on a first frequency and then down-clocked to a second frequency that corresponds to a bandwidth of one of the sub-channels. A wireless communication device configured to perform such operations may be compliant with one or more IEEE 802.11 communication standards, protocols, and/or recommended practices and may also be backward compatible with prior versions of IEEE 802.11. Different numbers of sub-channels and sub-channels of different bandwidths may be used to different times.

### CROSS REFERENCE TO RELATED PATENTS/PATENT APPLICATIONS

### Provisional Priority Claims

The present U.S. Utility patent application claims priority pursuant to 35 U.S.C. §119(e) to the following U.S. Provisional patent applications which are hereby incorporated herein by reference in their entirety and made part of the present U.S. Utility patent application for all purposes:

1. U.S. Provisional Patent Application Ser. No. 61/751,401, entitled “Next generation within single user, multiple user, multiple access, and/or MIMO wireless communications,” filed Jan. 11, 2013, pending.

2. U.S. Provisional Patent Application Ser. No. 61/831,789, entitled “Next generation within single user, multiple user, multiple access, and/or MIMO wireless communications,” filed Jun. 6, 2013, pending.

3. U.S. Provisional Patent Application Ser. No. 61/870,606, entitled “Next generation within single user, multiple user, multiple access, and/or MIMO wireless communications,” filed Aug. 27, 2013, pending.

4. U.S. Provisional Patent Application Ser. No. 61/873,512, entitled “Orthogonal frequency division multiple access (OFDMA) and duplication signaling within wireless communications,” filed Sep. 4, 2013, pending.

### BACKGROUND

1. Technical Field

The present disclosure relates generally to communication systems; and, more particularly, to multi-user communications and signaling within single user, multiple user, multiple access, and/or MIMO wireless communications.

2. Description of Related Art

Communication systems support wireless and wire lined communications between wireless and/or wire lined communication devices. The systems can range from national and/or international cellular telephone systems, to the Internet, to point-to-point in-home wireless networks and can operate in accordance with one or more communication standards. For example, wireless communication systems may operate in accordance with one or more standards including, but not limited to, IEEE 802.11x (where x may be various extensions such as a, b, n, g, etc.), Bluetooth, advanced mobile phone services (AMPS), digital AMPS, global system for mobile communications (GSM), etc., and/or variations thereof.

In some instances, wireless communication is made between a transmitter (TX) and receiver (RX) using single-input-single-output (SISO) communication. Another type of wireless communication is single-input-multiple-output (SIMO) in which a single TX processes data into RF signals that are transmitted to a RX that includes two or more antennae and two or more RX paths.

Yet an alternative type of wireless communication is multiple-input-single-output (MISO) in which a TX includes two or more transmission paths that each respectively converts a corresponding portion of baseband signals into RF signals, which are transmitted via corresponding antennae to a RX. Another type of wireless communication is multiple-input-multiple-output (MIMO) in which a TX and RX each respectively includes multiple paths such that a TX parallel processes data using a spatial and time encoding function to produce two or more streams of data and a RX receives the multiple RF signals via multiple RX paths that recapture the streams of data utilizing a spatial and time decoding function.

As wireless communication systems expand and/or support more devices, communications between those devices may be lost entirely or only able to be supported at very low data rates. In addition, when a significantly large number of devices operate within a given wireless communication system, there may be instances of less than fully efficient use of the communication medium and lower data rates.

### BRIEF DESCRIPTION OF THE SEVERAL VIEWS OF THE DRAWINGS

FIG. 1 is a diagram illustrating an embodiment of a wireless communication system.

FIG. 2 is a diagram illustrating an embodiment of dense deployment of wireless communication devices.

FIG. 3A is a diagram illustrating an example of communication between wireless communication devices.

FIG. 3B is a diagram illustrating an example of a processor and communication interface of a wireless communication device.

FIG. 4 is a diagram illustrating an example of orthogonal frequency division multiple access (OFDMA).

FIG. 5 is a diagram illustrating an example of a frequency band of one or more communication protocols partitioned into one or more channels and/or sub-channels.

FIG. 6A is a diagram illustrating an example of transmission of an OFDM frame.

FIG. 6B is a diagram illustrating another example of transmission of an OFDM frame.

FIG. 7A is a diagram illustrating an example of transmission of different OFDMA frames at different times using different sub-channels.

FIG. 7B is a diagram illustrating an example of transmission of different OFDMA frames at different times using different sub-channels of different sizes.

FIG. 8 is a diagram illustrating an example of down-clocking by different respective transceiver sections within a communication device.

FIG. 9 is a diagram showing a table comparing various downclocking options.

FIG. 10A is a diagram illustrating an example a preamble format for downclocked physical layer (PHY).

FIG. 10B is a diagram illustrating an embodiment of a method for execution by one or more wireless communication devices.

FIG. 10C is a diagram illustrating another embodiment of a method for execution by one or more wireless communication devices.

### DETAILED DESCRIPTION

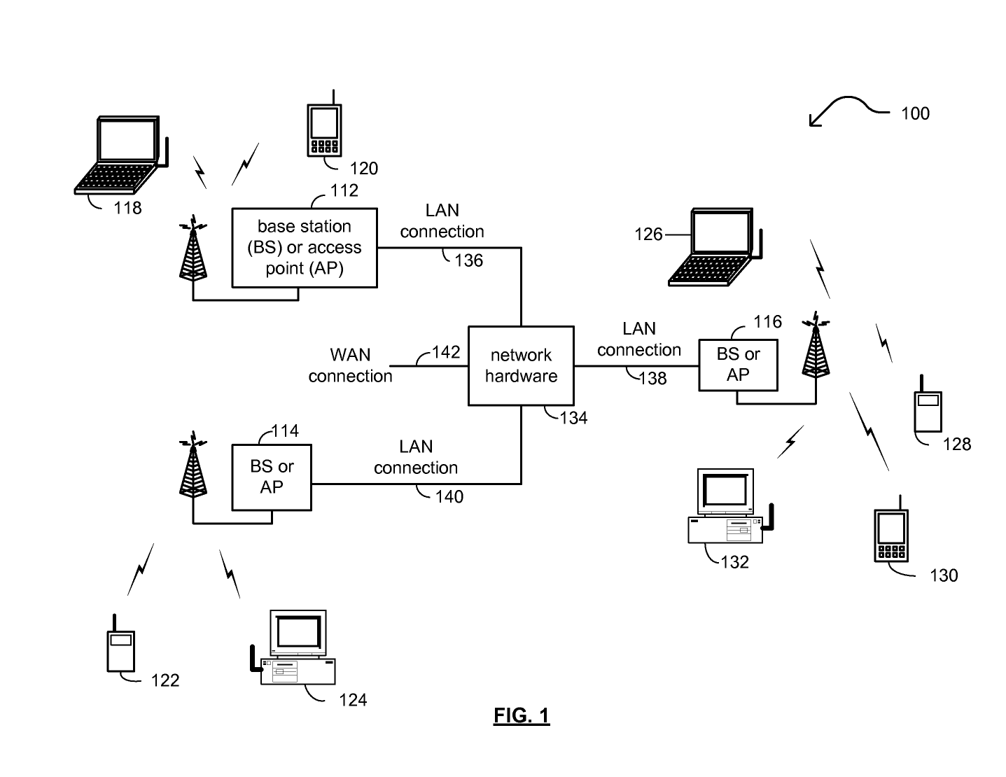

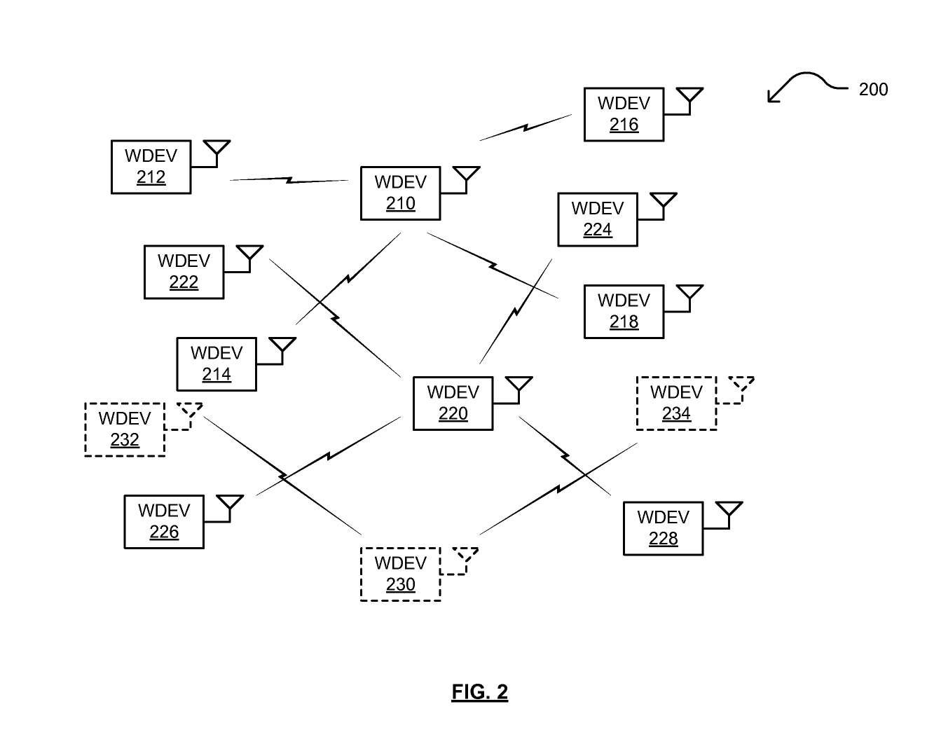

FIG. 1 is a diagram illustrating one or more embodiments of a wireless communication system 100. The wireless communication system 100 includes base stations and/or access points 112-116, wireless communication devices 118-132 (e.g., wireless stations (STAs)), and a network hardware component 134. The wireless communication devices 118-132 may be laptop computers, or tablets, 118 and 126, personal digital assistant 120 and 130, personal computer 124 and 132 and/or cellular telephone 122 and 128. The details of an embodiment of such wireless communication devices are described in greater detail with reference to FIG. 2.

The base stations (BSs) or access points (APs) 112-116 are operably coupled to the network hardware 134 via local area network connections 136, 138, and 140. The network hardware 134, which may be a router, switch, bridge, modem, system controller, etc., provides a wide area network connection 142 for the communication system 100. Each of the base stations or access points 112-116 has an associated antenna or antenna array to communicate with the wireless communication devices in its area. Typically, the wireless communication devices register with a particular base station or access point 112-116 to receive services from the communication system 100. For direct connections (i.e., point-to-point communications), wireless communication devices communicate directly via an allocated channel.

Any of the various wireless communication devices (WDEVs) 118-132 and BSs or APs 112-116 may include a processor and a communication interface to support communications with any other of the wireless communication devices 118-132 and BSs or APs 112-116. In an example of operation, a processor implemented within BS or AP 114 can generate a frame (e.g., an orthogonal frequency division multiple access (OFDMA) frame) that includes data for both device 122 and 124. The communication interface implemented within BS or AP 114 then transmits the frame to the devices 122 and 124. BS or AP 114 transmits the frame via a first one or more sub-channels or channels and also transmits a duplicate of that frame via a second one or more sub-channels or channels.

Generally, a processor within one of the wireless communication devices 118-132 and BSs or APs 112-116 operates to generate the frame (e.g., OFDMA frame) in the digital domain. In some instances, such a processor implemented within a device is a baseband processor that operates in the digital domain based on a baseband clock or frequency in the device. Then, based on the frame, a communication interface of the device generates the continuous time signal to be transmitted to another device. The communication interface may perform a number of different functions including digital to analog conversion (e.g., using one or more digital to analog converters (DACs)), frequency conversion (e.g., frequency up-clocking and/or down-clocking), filtering (analog and/or digital), scaling, modulation, etc. to generate the signal to be transmitted to the other device.

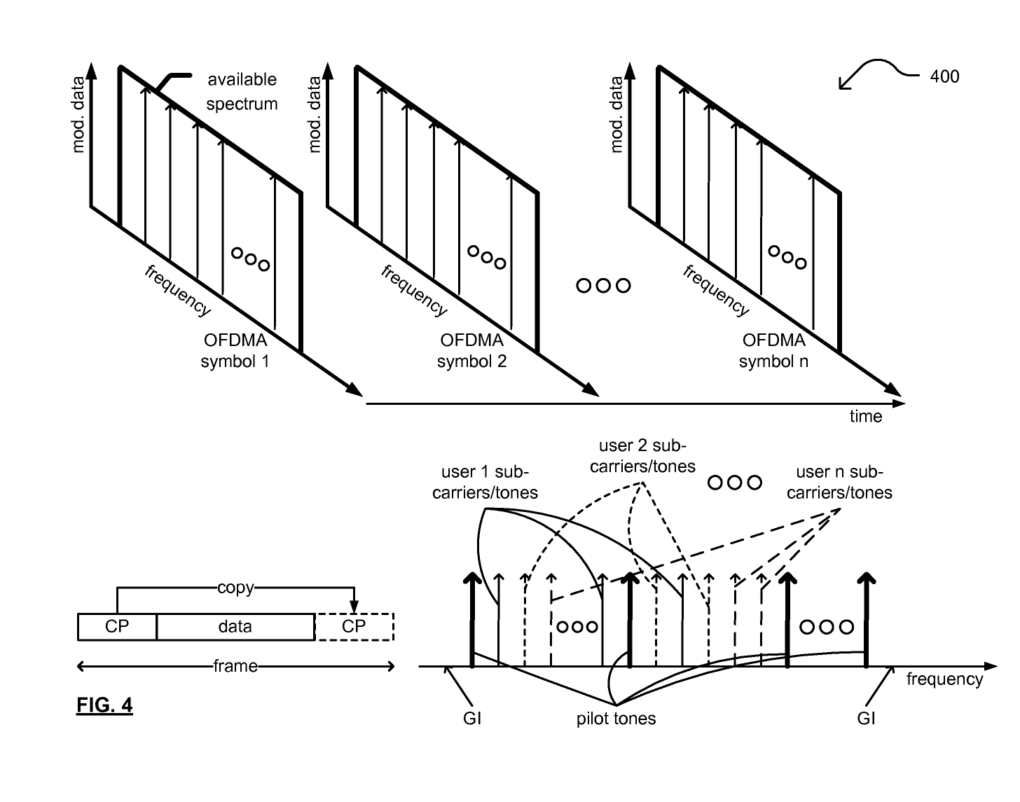

Generally, OFDMA is a modification of orthogonal frequency division multiplexing (OFDM) such that different subcarriers are assigned to different respective users. Further details regarding OFDMA signaling are provided below with reference to FIG. 4. In some instances, additional duplicates of that frame are transmitted via additional sub-channels as well. Transmissions based on OFDMA signaling may be directed to any desired number of recipient devices (e.g., 1, 2, 3, etc.).

Transmission of a frame more than once (e.g., using one or more duplicates of the frame) and via more than one sub-channel can allow for significantly extended range between devices. For example, a device that receives more than one copy of a frame via one or more sub-channels may employ such frame redundancy to correct for any information lost during transmission or any errors included within any one frame. Also, OFDMA signaling allows for transmission of information for different respective users within a single frame. Some information within an OFDMA frame may be intended for more than one recipient device, and other information within an OFDMA frame may be intended for as few as one recipient device. OFDMA signaling allows for an increase of throughput within the wireless communication system and a more efficient use of the communication medium. A channel having a first bandwidth may be divided into a number of sub-channels each having a second bandwidth. Alternatively, one of the sub-channels may have a different bandwidth than other of these sub-channels. For example, a channel may have a bandwidth of 80 MHz and be divided into 4 sub-channels of 20 MHz bandwidth. In addition, any sub-channel may be further divided into other sub-channels (e.g., a 20 MHz bandwidth channel may be subdivided into two 10 MHz sub-channels, four 5 MHz sub-channels, ten 2 MHz sub-channels, etc. or any desired combination of sub-channels having different bandwidths).

A recipient device may operate based on an entire channel or one or more of the sub-channels of an overall channel. For example, a recipient device may scan the entire bandwidth of the overall channel or may operate based on one or more of the overall channels sub-channels. For example, a recipient device may operate based on two sub-channels of 20 MHz bandwidth included within an overall channel having an 80 MHz bandwidth.

Note that certain of the wireless communication devices 118-132 and BSs or APs 112-116 may be operative based on one or more IEEE 802.11 communication standards, protocols, and/or recommended practices (e.g., IEEE 802.11x, where x may be various extensions such as a, b, n, g, ac, ah, af, etc.). A device that can operate based on a newer or more recent version of IEEE 802.11 may also be backward compatible with one or more prior versions of IEEE 802.11.

FIG. 2 is a diagram illustrating an embodiment 200 of dense deployment of wireless communication devices (shown as WDEVs in the diagram). Any of the various WDEVs 210-234 may be access points (APs) or wireless stations (STAs). For example, WDEV 210 may be an AP or an AP-operative STA that communicates with WDEVs 212, 214, 216, and 218 that are STAs. WDEV 220 may be an AP or an AP-operative STA that communicates with WDEVs 222, 224, 226, and 228 that are STAs. In certain instances, one or more additional APs or AP-operative STAs may be deployed, such as WDEV 230 that communicates with WDEVs 232 and 234 that are STAs. The STAs may be any type of wireless communication devices such as wireless communication devices 118-132, and the APs or AP-operative STAs may be any type of wireless communication devices such as BSs or APs 112-116.

This disclosure presents novel architectures, methods, approaches, etc. that allow for improved spatial re-use for next generation WiFi or wireless local area network (WLAN/WiFi) systems. Next generation WiFi systems are expected to improve performance in dense deployments where many clients and AP are packed in a given area (e.g., which may be a relatively area [indoor or outdoor] with a high density of devices, such as a train station, airport, stadium, building, shopping mall, etc. to name just some examples). Large numbers of devices operative within a given area can be problematic if not impossible using prior technologies. OFDMA signaling allows for any given frame to include information intended for more than one recipient device. In addition, the transmission of one or more duplicates of an OFDMA frame ensures more successful communication between devices. While the overall information rate may be considered to be reduced, given the repeated transmission of an OFDMA frame within two or more sub-channels, such transmissions are relatively more robust and can cover larger areas (e.g., extended range) than transmissions of a single instance of the OFDMA frame using the entirety of the channel's bandwidth.

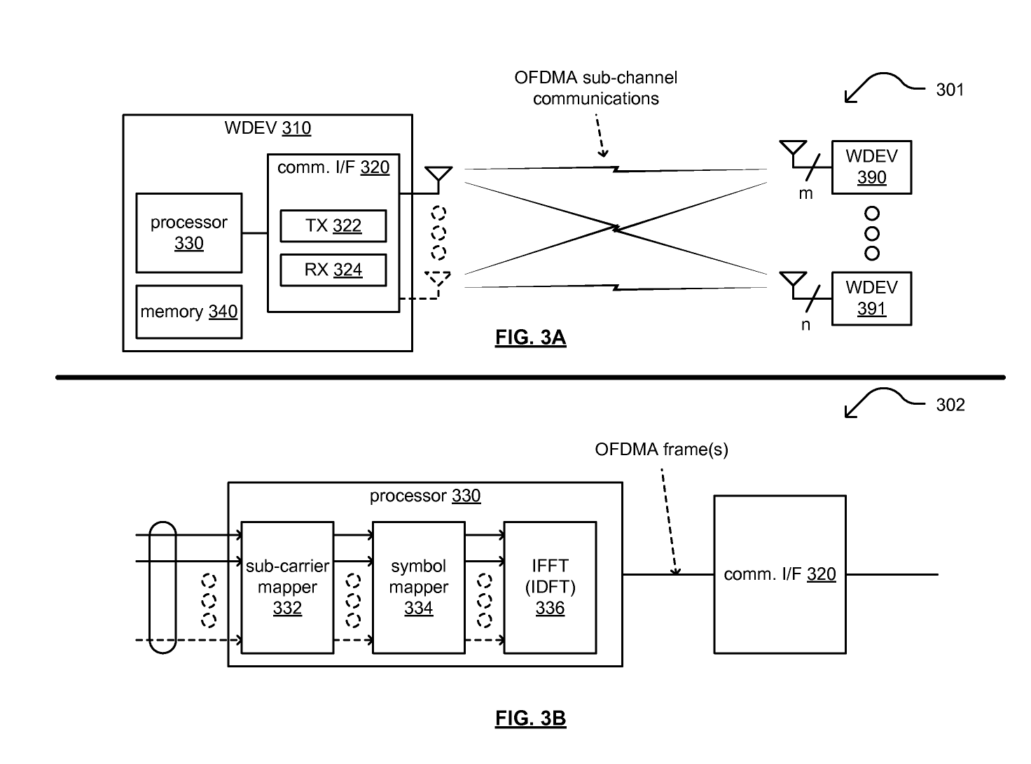

FIG. 3 is a diagram illustrating an example 300 of communication between wireless communication devices. A wireless communication device 310 (e.g., which may be any one of devices 118-132 as with reference to FIG. 1) is in communication with another wireless communication device 390 via a transmission medium. The wireless communication device 310 includes a communication interface 320 to perform transmitting and receiving of one or more frames (e.g., using a transmitter 322 and a receiver 324). The wireless communication device 310 also includes a processor 330, and an associated memory 340, to execute various operations including interpreting one or more frames transmitted to wireless communication device 390 and/or received from the wireless communication device 390 and/or wireless communication device 391. The wireless communication devices 310 and 390 may be implemented using one or more integrated circuits in accordance with any desired configuration or combination or components, modules, etc. within one or more integrated circuits. Also, the wireless communication devices 310, 390, and 391 may each include more than one antenna for transmitting and receiving of one or more frames (e.g., WDEV 390 may include m antennae, and WDEV 391 may include n antennae).

The device 310's processor 330 is configured to generate a frame (e.g., an OFDMA frame) that includes first data for a first other wireless communication device and second data for a second other wireless communication device. The device 310's communication interface 320 is configured to transmit the frame via a first one or more sub-channels or channels and a duplicate of the frame via a second one or more sub-channels or channels to the first and second other wireless communication devices 390-391.

FIG. 3B is a diagram illustrating an example 302 of a processor 330 and communication interface 320 of a wireless communication device. As mentioned briefly above as with reference to FIG. 1, processor 330 implemented within a device 310 may operate primarily in the digital domain (e.g., such as implemented via a baseband processor). The processor 330 operates on data associated with one or more users/recipients. In an orthogonal frequency division multiple access (OFDMA) context, the processor 330 performs subcarrier mapping of the data associated with two or more users to the orthogonal frequency division multiplexing (OFDM) subcarriers or tones (block 332). Then, the processor 330 modulates each of the subcarriers or tones using some type of modulation (e.g., symbol mapper 334) such as quadrature phase shift keying (QPSK), binary phase shift keying (BPSK), 16 quadrature amplitude modulation (QAM), 32 amplitude phase shift keying (APSK), and/or any other type of modulation typically including a constellation and bit or symbol labels associated with the points in that constellation. Then, the processor 330 performs an inverse fast Fourier transform (IFFT) (or inverse discrete fast Fourier transform (IDFT)) (block 336) on each set of symbols to generate a set of complex time-domain samples. These samples may then undergo processing within the communication interface 320 to generate a continuous-time signal for transmission to another device via one or more communication channels or sub-channels. The communication interface 320 may perform a number of different functions including digital to analog conversion, frequency conversion (e.g., oftentimes frequency up-clocking), filtering, modulation, etc. to generate the signal to be transmitted to the other device. Generally, the processor 330 generates one or more frames to be transmitted to one or more other devices, and the communication interface 320 performs those operations necessary to transform the one or more frames into continuous-time signal for transmission to those one or more other devices via one or more communication channels or sub-channels.

FIG. 4 is a diagram illustrating an example 400 of orthogonal frequency division multiple access (OFDMA). Orthogonal frequency division multiplexing (OFDM) modulation may be viewed a dividing up an available spectrum into a plurality of narrowband sub-carriers (e.g., lower data rate carriers). Typically, the frequency responses of these sub-carriers are overlapping and orthogonal. Each sub-carrier may be modulated using any of a variety of modulation coding techniques (e.g., as shown by the vertical axis of modulated data). Comparing OFDMA to OFDM, OFDMA is a multi-user version of the popular orthogonal frequency division multiplexing (OFDM) digital modulation scheme. Multiple access is achieved in OFDMA by assigning subsets of subcarriers to individual recipient devices for users. For example, first sub-carrier(s)/tone(s) may be assigned to a user 1, second sub-carrier(s)/tone(s) may be assigned to a user 2, and so on up to any desired number of users. In addition, such sub-carrier/tone assignment may be dynamic among different respective transmissions (e.g., a first assignment for a first frame, a second assignment for second frame, etc.). An OFDMA frame may include more than one OFDMA symbol. In addition, such sub-carrier/tone assignment may be dynamic among different respective symbols within a given (e.g., a first assignment for a first OFDMA symbol within a frame, a second assignment for a second OFDMA symbol within the frame, etc.).

OFDM and/or OFDMA modulation may operate by performing simultaneous transmission of a large number of narrowband carriers (or multi-tones). A guard interval (GI) or guard space is sometimes employed between the various OFDM symbols to try to minimize the effects of ISI (Inter-Symbol Interference) that may be caused by the effects of multi-path within the communication system, which can be particularly of concern in wireless communication systems. In addition, a CP (Cyclic Prefix) may also be employed within the guard interval to allow switching time, such as when jumping to a new communication channel or sub-channel, and to help maintain orthogonality of the OFDM and/or OFDMA symbols. Generally speaking, an OFDM and/or OFDMA system design is based on the expected delay spread within the communication system (e.g., the expected delay spread of the communication channel).

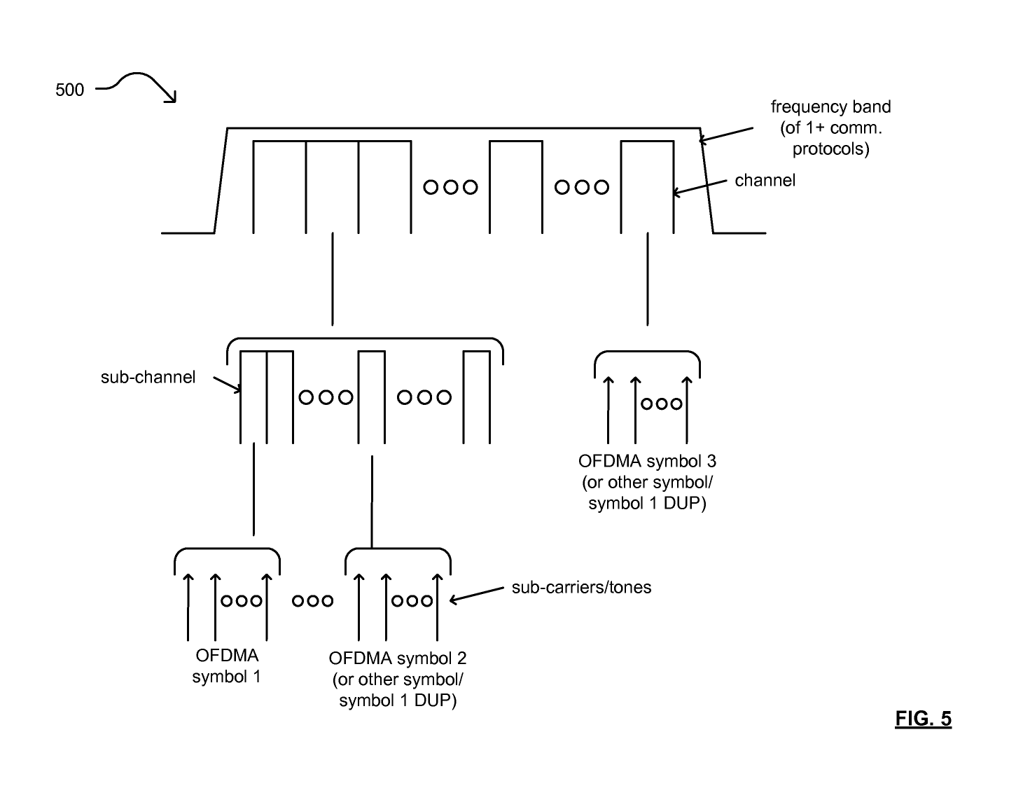

FIG. 5 is a diagram illustrating an example 500 of a frequency band of one or more communication protocols partitioned into one or more channels and/or sub-channels. An OFDMA frame may include one or more OFDMA symbols. An OFDMA frame may be transmitted via one or more channels or one or more sub-channels of one or more frequency bands associated with one or more communication protocols. For example, certain communication standards operate in a known frequency bands. As some specific examples, certain IEEE 802.11 communication standards operate using defined frequency bands centered around some known frequency (e.g., 2.4, 3.6, 6, 60 giga-Hertz (GHz)).

Note also that a certain frequency band may be divided into one or more channels, and any given channel may be divided into one or more sub-channels. An OFDMA frame may be transmitted within any one or more sub-channels and/or any one or more channels of the frequency band associated with one or more communication protocols. With reference to FIG. 4, an OFDMA frame may include one or more OFDMA symbols, and a given OFDMA symbol includes one or more subcarriers or tones. The subcarriers or tones of a given OFDMA symbol or OFDMA frame may correspond to one or more of these sub-channels or one or more of the channels of the frequency band associated with one or more communication protocols.

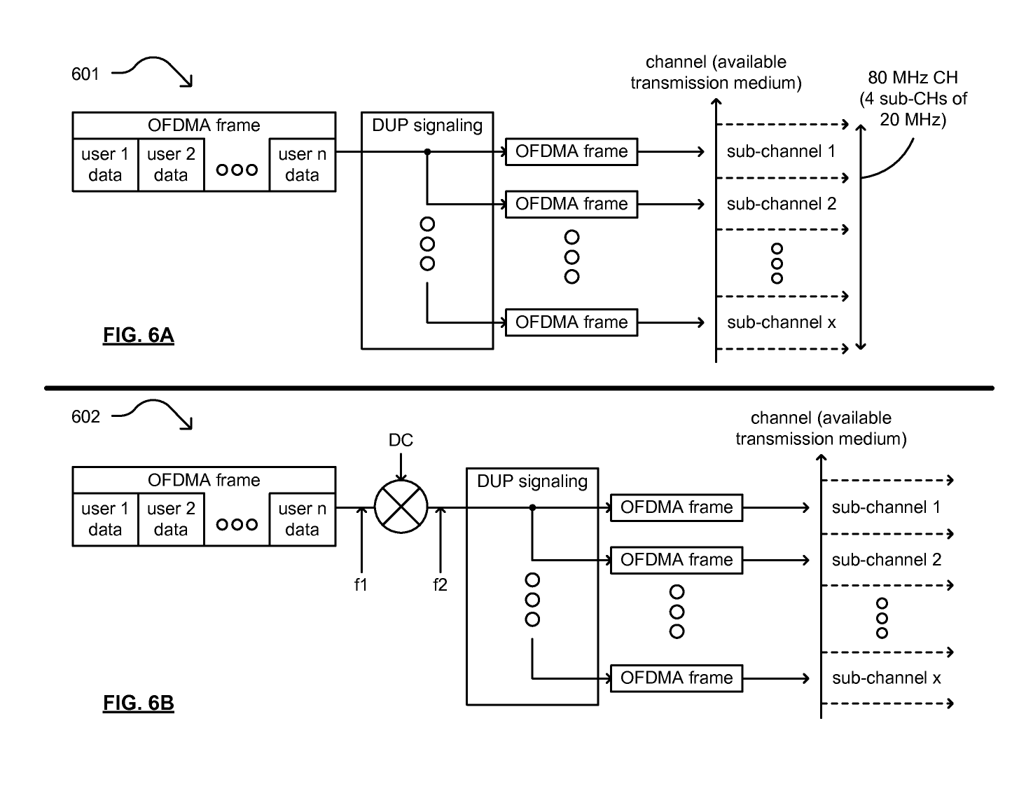

FIG. 6A is a diagram illustrating an example 601 of transmission of an OFDM frame. An OFDMA frame includes data for a number of users, shown as user 1, user 2, up a user n. An OFDMA frame may include data for any desired number of users, including as few as one user. The OFDMA frame is transmitted via two or more sub-channels. For example, the OFDMA frame is transmitted via a sub-channel 1, and a duplicate of the OFDMA frame is transmitted via a sub-channel 2. Such duplicate processing (shown in a DUP signaling block) may be performed by a communication interface of a given wireless communication device. Alternatively, such duplicate processing (shown in a DUP signaling block) may be performed by a processor of a given wireless communication device (e.g., in digital domain, baseband processing domain, etc. before digital to analog conversion to generate a continuous time signal for transmission via a communication channel). Note that such duplicate processing may be performed using any desired implementation of baseband processing (e.g., such as with a processor of the device) or radio frequency (RF) front end processing (e.g., such as within a communication interface of the device) as may be desired.

In certain instances, additional duplicates of the DMA frame are transmitted via additional sub-channels. Note that the sub-channels via which the OFDMA frame and one or more duplicates of the OFDMA frame are transmitted may occupy less than all of the overall channel. Considering one particular implementation, if an overall channel has a bandwidth of 80 MHz that is subdivided into 4 sub-channels each of 20 MHz bandwidth, then the OFDMA frame may be transmitted via the sub-channel 1 of 20 MHz bandwidth, and the duplicate of the OFDMA frame may be transmitted via the sub-channel 2 of 20 MHz bandwidth.

FIG. 6B is a diagram illustrating another example 602 of transmission of an OFDM frame. This diagram has similarities to the prior diagram with at least one difference being that a frequency of the OFDMA frame is modified before undergoing duplicate processing. A wireless communication device's processor may be configured to down-clock the OFDMA frame from a first frequency to a second frequency that is lower than the first frequency. Alternatively, wireless communication device's processor may be configured to up-clock the OFDMA frame from the first frequency to a third frequency that is higher than the first frequency.

A device having physical layer (PHY) components tailored to the first frequency may be used to support communications based on the second or third frequencies. For example, a device's PHY may download-clock an OFDMA frame from the first frequency to the second frequency. These different frequencies may correspond to different operation based on different IEEE 802.11 communication standards, protocols, and/or recommended practices. For example, the first frequency may be based on operation associated with IEEE 802.11ac, and the second frequency may be based on operation associated with a subsequent or later version of IEEE 802.11. In such an instance, a device that includes components for operation with IEEE 802.11ac may be modified very slightly to support operation with a subsequent or later version of IEEE 802.11.

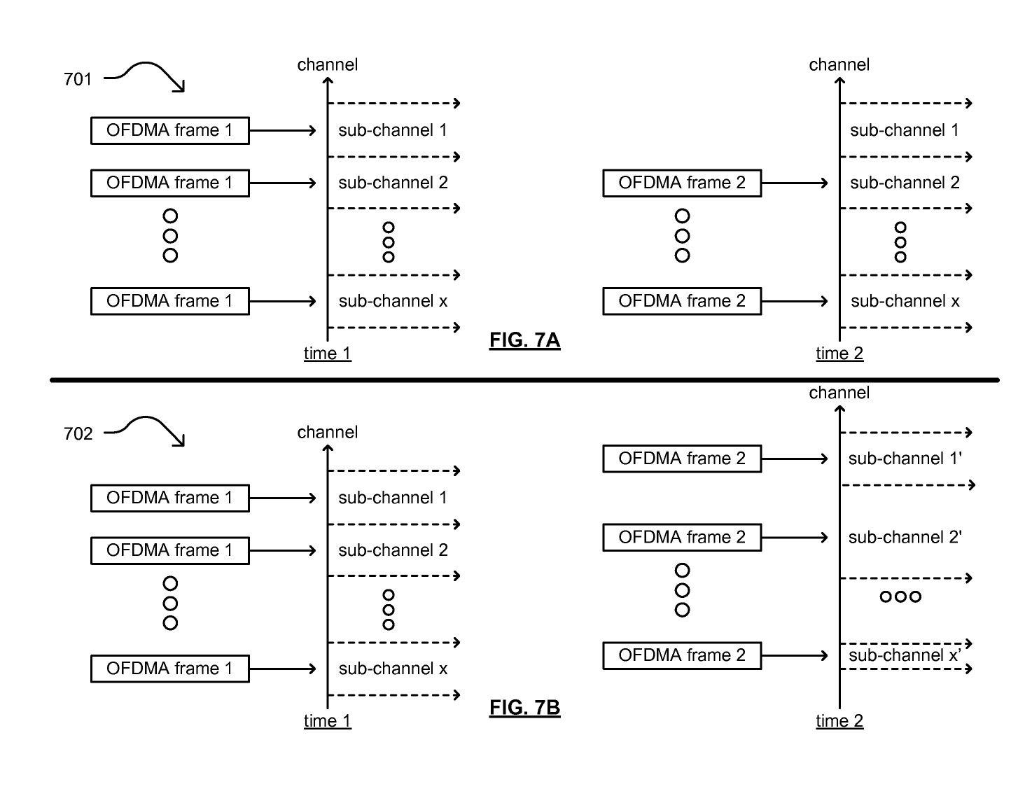

FIG. 7A is a diagram illustrating an example 701 of transmission of different OFDMA frames at different times using different sub-channels. During a first time, an OFDMA frame 1 and one or more duplicates of it are transmitted via a first number of sub-channels, shown as sub-channels 1, 2, and so on up to x. Then, during a second time, an OFDMA frame 2 and one or more duplicates of it are transmitted via a second number of sub-channels, shown as sub-channels 2 up to x. During subsequent times, other OFDMA frames and one or more duplicates of them may be transmitted via other numbers of sub-channels.

In the example of this diagram, the transmission via the first and second numbers of sub-channels show adjacent sub-channels used for transmission. However, there may be one or more non-used sub-channels intermingled among those sub-channels used for transmission. For example, transmission of an OFDMA frame may be performed using sub-channel 1 and sub-channel x such that the sub-channels in between 1 and x are not used for transmission.

FIG. 7B is a diagram illustrating an example 702 of transmission of different OFDMA frames at different times using different sub-channels of different sizes. During a first time, an OFDMA frame 1 and one or more duplicates of it are transmitted via a first number of sub-channels, shown as sub-channels 1, 2, and so on up to x. The sub-channels 1, 2, up to x are shown as each having a common bandwidth. When, Then, during a second time, and OFDM frame 2 and one or more duplicates of it are transmitted via a second number of sub-channels, shown as sub-channels 1′, 2′, up to x′. Sub-channels 1′, 2′, up to x′ do not necessarily have the same bandwidth. Also, the overall bandwidth occupied by the sub-channels 1′, 2′, up to x′ may not necessarily be the same as the overall bandwidth occupied by the sub-channels 1, 2, up to x. Different respective sub-channels of different respective bandwidth may be employed for transmission of other OFDMA frames and one or more duplicates of them.

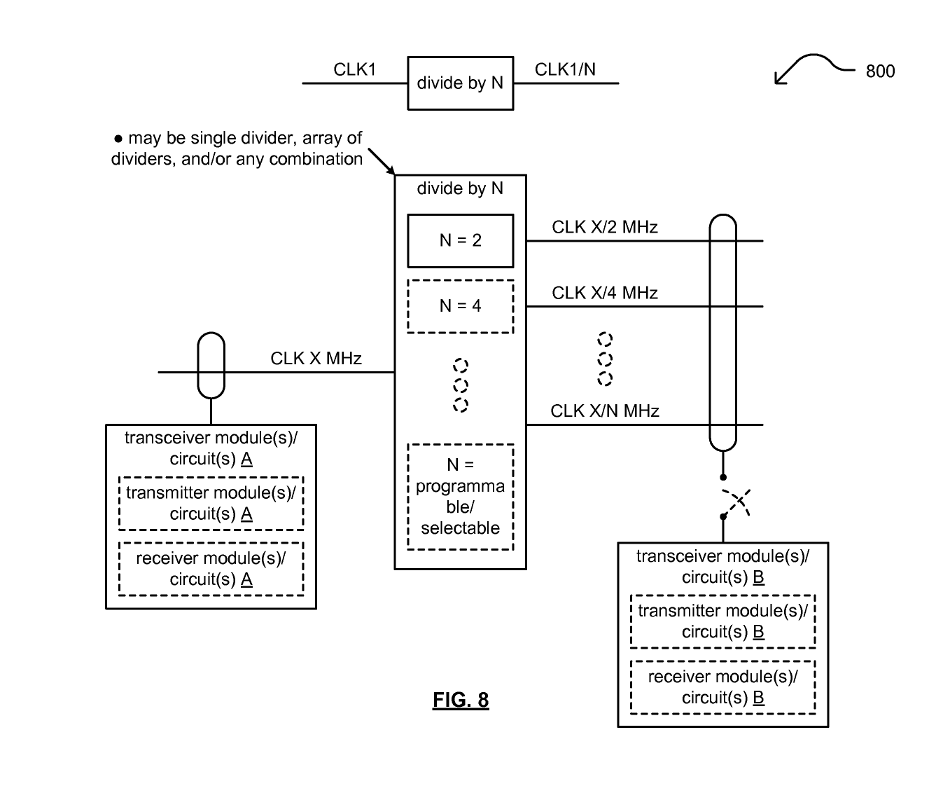

FIG. 8 is a diagram illustrating an example 800 of down-clocking by different respective transceiver sections within a communication device. Such down-clocking described in FIG. 8 may be performed in the example of FIG. 6B. Note that such down-clocking may be performed using any desired implementation of baseband processing (e.g., such as with a processor of the device) or radio frequency (RF) front end processing (e.g., such as within a communication interface of the device) as may be desired.

Wireless communication devices may be implemented to operate within any desired frequency spectrum. Portions of the frequency spectrum typically dedicated for such use in one application may alternatively and/or instead be used for operating wireless communication devices in other applications such as wireless local area network (WLAN/WiFi) or other wireless communication systems, networks, etc.

A clocking ratio of a desired ratio (e.g., generally, N) is operative to generate any one of a number of different respective signals. For example, considering a channel with an X MHz bandwidth (where X may be any desired number), down-clocking a channel by a value of 2 would provide for X/2 MHz channels. Alternatively, considering an X MHz channel, down clocking by a value of 4 would provide for X/4 MHz channels.

Generally speaking, processor may be configured to perform divide by N to down clocking of a given signal (e.g., such as one having a frequency of 20 MHz, or some other frequency) to generate at least one down clocked signal (e.g., having a frequency of 20/N MHz).

Such down-clocking may be programmable and/or selectable. For example, a wireless communication device may be configured to select any one of a number of different respective bandwidth channels based on any of a number of considerations. In one instance, 2 MHz bandwidth channels may be preferable; in another instance, 3 MHz bandwidth channels may be desirable; and in yet another instance, 5 MHz channels may be acceptable. Generally, appropriate down-clocking of a signal may provide for a signal that can have properties acceptable for use within any desired bandwidth channels.

The combination of OFDMA and duplication signaling provides for, among other things, improvement of delay spread immunity in WLAN applications operating in the 2.4 GHz and 5 GHz ranges and also more efficient use of the communication medium to allow multiple users, currently to share the channel. Such improvements may be provided within with wireless communication device while still maintaining backward compatibility with legacy IEEE 802.11 devices. For example, certain designs of devices can re-use much of existing physical layer (PHY) designs from prior standards, protocols, and/or recommended practices (e.g., IEEE 802.11ac and IEEE 802.11ah (32 FFT, 64 FFT, 128 FFT, 256 FFT and 512 FFT)). Also, the combination of OFDMA and duplication signaling can increase delay spread immunity via the downclocking (DC) operations described herein. Any desired DC factor may be used, and DC factors of 2 and 4 may sufficient for certain expected outdoor channel models.

Lower data rates can be achieved by repetition or duplication signaling in the same bandwidth (BW) or by using sub-channels of narrower BW. Some examples that achieve a factor of 4 reduction in rates and 6 dB link gain in additive white Gaussian noise (AWGN) are provide below.

Instead of using 64 FFT in a 20 MHz channel, an alternative implementation may use the 32 FFT PHY duplicated twice (e.g., which may be referred to as 32 FFT DUP mode) to achieve reduced rate by a factor of 2. The 32 FFT PHY developed for IEEE 802.11ah contains a mode using MCS0 with repetition which provides another reduction of the rate by a factor of 2 for a total reduction of rate by a factor of 4. This OFDM mode provides equivalent rate to IEEE 802.11b using an OFDM PHY design.

Alternatively, the uplink (UL) or downlink (DL) may operate using narrower channels. Instead of occupying 20 MHz, some examples may occupy 5 MHz to reduce the lowest bit rate by the same factor of 4. This can be achieved via several options (e.g., define a new 16 FFT PHY, use the 32 FFT PHY combined with DC=2, use the 64 FFT PHY combined with DC=4, etc.).

Specifically in the UL, narrower sub-channels may be more desirable or preferred based on an efficient OFDMA scheme that allows multiple users share the channel at the same time such that each used gets a portion of the BW (e.g., 5 MHz each). Also, in 2.4 GHz, using OFDMA with 5 MHz or narrower BW channels provides a solution to partially overlapping channels, which can be problematic in 2.4 GHz WLAN deployments, since some of the users will not experience interference.

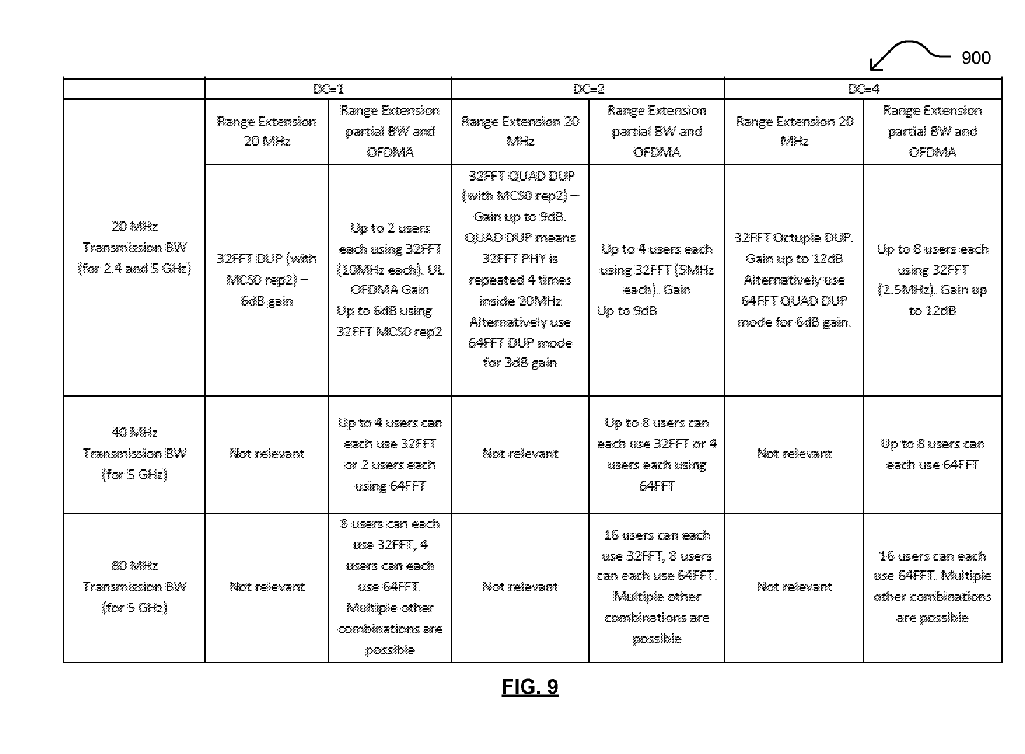

FIG. 9 is a diagram showing a table 900 comparing various downclocking options. This table provides a summary of options that may be considered to provide range extension for a 20 MHz (e.g., which is the basic unit of BW in 2.4 GHz and 5 GHz) signal. Range extension may be performed using narrower channels for UL OFDMA and improved delay spread immunity. Some practical implementations may limit the number of options to allow usage of 5 MHz sub-channels for transmissions inside a 20 MHz BW, 10 MHz sub-channels for transmissions inside a 40 MHz BW and 20 MHz sub-channels for transmission inside an 80 MHz BW. It is noted that the combination of DC and UL OFDMA can provide both increased delay spread immunity, improved UL link budget and improved efficiency at the same time by allowing 4 or more users to share a 20 MHz BW using a downclocked PHY.

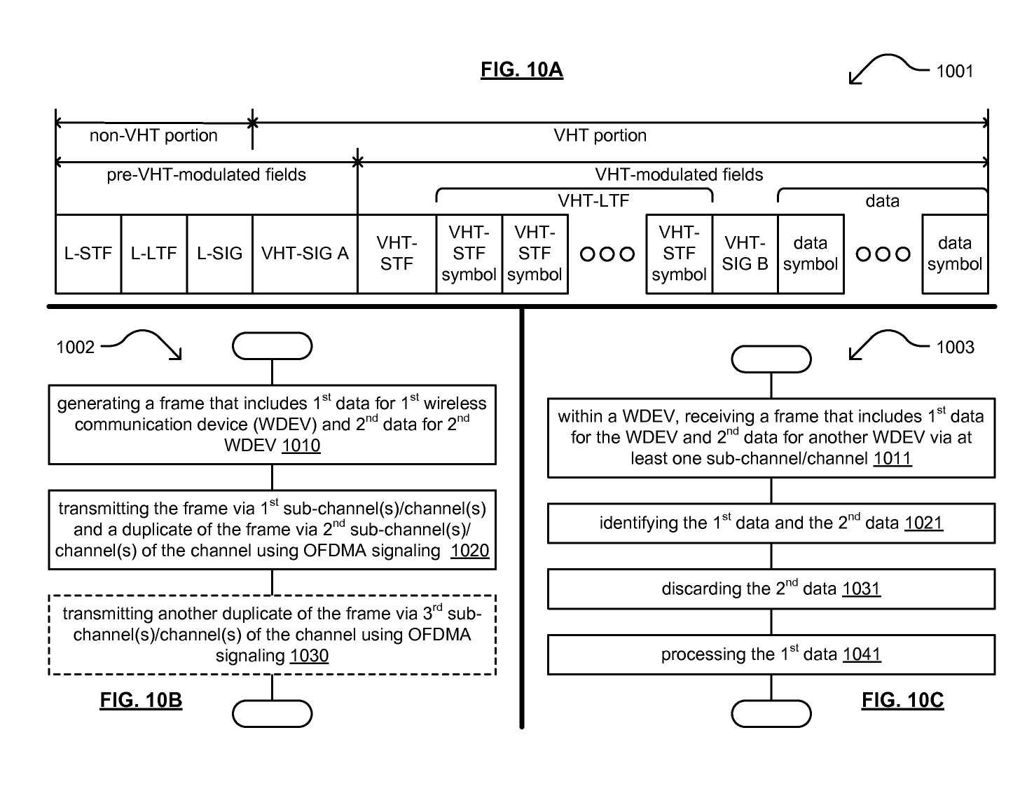

FIG. 10A is a diagram illustrating an example 1001 a preamble format for downclocked physical layer (PHY). Such a general preamble format may be backward compatible with prior IEEE 802.11x prior standards, protocols, and/or recommended practices including those related to, among others, IEEE 802.11af. Note that in the context of such a preamble, a unit of 20 MHz is maintained, hence DC=2 and DC=4 means that instead of using an FFT of size 64 FFT, FFTs of 128 FFT and 256 FFT are respectively used for 20 MHz symbols.

A legacy portion of the IEEE 802.11ac preamble format (e.g., shown in the diagram as non-VHT [Very High Throughput] portion) is transmitted as-is (e.g., so legacy communication devices can decode it and get the length information in the L-signal field (SIG) field), followed by a downclocked version (e.g., using DC=2 or DC=4) of the VHT portion. Alternatively, packets using the new format can omit the Legacy non-VHT portion and a legacy formatted packets can be sent initially to reserve the medium using a request to send/clear to send (RTS/CTS) exchange or CTS2SELF.

Herein, several variants are presented that trade off preamble length with delay spread immunity. Note that with DC=2(4) the short training field (STF) and long training field (LTF) fields increase by a factor of 2(4), and this increases the preamble overhead in absolute μs (micro-seconds). The VHT portion uses DC=4 (e.g., which may be preferred or best for delay spread immunity but longer preamble). The VHT portion uses DC=2.

The VHT-SIGA field uses DC=2 and a bit in the SIG-A indicates whether the ‘VHT modulated fields’ portion of the packet uses DC=2 or DC=4. Also, note that this provides more flexibility to adapt the PHY to various outdoor delay spread scenarios and by noting that higher MCS are more sensitive to delay spread exceeding the OFDM GI. As such, higher DC ratios may be needed for DATA whereas the VHT-SIGA uses the lowest MCS (e.g., MCS0) and is more robust under long delay spread channels.

The VHT-SIGA field uses DC=1 and a bit in the SIG-A indicates whether the ‘VHT modulated fields’ portion of the packet uses DC=1 or DC=2. In some instances, it is possible to have 2 bits to signal whether DC=1, DC=2 or DC=4 are used for the ‘VHT modulated fields’. However, it is less likely that DC=4 will be required to correctly decode high MCS while DC=1 is sufficient for decoding VHT-SIGA.

The two options above can include the CP in front of the VHT SIG-A in a double length option (DGI). This can be in a similar fashion to the CP length in front of the L-LTF in order to provide the VHT-SIGA with extra immunity from long delay spread channels.

Note also that that keeping the ratio of the supported downclocking ratios within one packet to an exponent of 2 may be preferable to make implementation relatively less complex. In cases where the downclocked version of the VHT portion needs to fit into a 20 MHz BW and is not using a DUP structure as described in table 900 of FIG. 9, the SIG field can use a larger FFT size to reduce the number of symbols.

Some examples are provided below:

With DC=2, instead of using two 64 FFT symbols for VHT-SIG-A containing altogether 48 information bits, one symbol of 128 FFT can be used. In this case, the VHT SIG-A can contain all the information bits in the current SIG-A since it has a capacity of 54 bits.

With DC=4, use one symbol of 256 FFT. In this case, the capacity is 117 bits and is far more than is needed even if all the SIG-A and SIG-B bits are assigned into it. An alternative option is to combine the LTF and the SIG field together in one symbol. In this option, the LTF pilots occupy only the even (or odd) tones and the SIG field contains the rest of the tones. This option provides capacity for 58 bits of information. Note also that such a new preamble designs presented herein may use tail-biting codes in the SIG field in order to save 6 bits.

FIG. 10B is a diagram illustrating an embodiment of a method 1002 for execution by one or more wireless communication devices. The method 1002 begins by generating a frame that includes first data for a first wireless communication device and second data for a second wireless communication device (block 1010). Then, the method 1002 operates by transmitting the frame via a first one or more sub-channels or channels and a duplicate of the frame via a second one or more sub-channels or channels using OFDMA signaling (block 1020). Based on such OFDMA signaling, one or more first sub-carriers are employed to carry the first data, and one or more second sub-carriers are employed to carry the second data.

In some instances, the method 1002 operates by transmitting another duplicate of the frame via a third one or more sub-channels or channels (box 1030). Generally, any desired number of duplicates of the frame may be transmitted via any desired number of sub-channels. The method 1002 may be viewed as being performed within a wireless communication device that performs transmission operations.

FIG. 10C is a diagram illustrating another embodiment of a method 1003 for execution by one or more wireless communication devices. The method 1003 may be viewed as being performed within a wireless communication device that performs reception operations. Within the wireless communication device, the method 1003 operates by receiving a frame that includes first data for that wireless communication device and second data for another wireless communication device the at least one sub-channel and/or channel (block 1011). The method 1003 then operates by identifying the first in the second data (block 1021). The method 1003 continues by discarding the second data (block 1031) and processing the first data (block 1041). Generally, such operations are directed towards identifying and processing data included within the frame that is intended for that wireless communication device. Based on OFDMA signaling, such operations include identifying and processing information carried via the sub-carriers associated with that wireless communication device.

In some instances, the frame may also include additional data intended for additional wireless communication devices. In even other instances, the frame may include data intended for more than one wireless communication device (e.g., data intended for two or more or even up to all of a number of wireless communication devices). A wireless communication device performing the operations of the method 702 will identify and process all data intended for an associated with that wireless communication device and will identify and discard all data not intended for that wireless communication device.

Note that the various operations and functions described within various methods herein may be performed within a wireless communication device (e.g., such as by the wireless communication device 310 as described with reference to FIG. 3A and portions shown in FIG. 3B). Generally, a communication interface and processor in a wireless communication device can perform such operations.

Examples of some components may include one of more baseband processing modules, one or more media access control (MAC) layers, one or more physical layers (PHYs), and/or other components, etc. For example, such a baseband processing module (sometimes in conjunction with a radio, analog front end (AFE), etc.) can generate such signals, frames, etc. as described herein as well as perform various operations described herein and/or their respective equivalents.

In some embodiments, such a baseband processing module and/or a processing module (which may be implemented in the same device or separate devices) can perform such processing to generate signals for transmission to another wireless communication device using any number of radios and antennae. In some embodiments, such processing is performed cooperatively by a processor in a first device and another processor within a second device. In other embodiments, such processing is performed wholly by a processor within one device.

The present invention has been described herein with reference to at least one embodiment. Such embodiment(s) of the present invention have been described with the aid of structural components illustrating physical and/or logical components and with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims that follow. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may also be used herein, the terms “processing module,” “processing circuit,” “processing circuitry,” and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art. The term “module” is used in the description of one or more of the embodiments.

A module includes a processing module, a functional block, hardware, and/or software stored on memory for performing one or more functions as may be described herein. Note that, if the module is implemented via hardware, the hardware may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure of an invention is not limited by the particular examples disclosed herein and expressly incorporates these other combinations.

What is claimed is:

1. A wireless communication device comprising:
a processor configured to generate an orthogonal frequency division multiple access (OFDMA) frame that includes first data for a first other wireless communication device mapped to a first one or more sub-carriers and second data for a second other wireless communication device mapped to a second one or more sub-carriers; and
a communication interface configured to transmit the OFDMA frame via a first sub-channel or channel of a frequency band and a duplicate of the OFDMA frame via a second sub-channel or channel of the frequency band to the first and second other wireless communication devices.

2. The wireless communication device of claim 1 further comprising:
the processor configured to generate the duplicate of the OFDMA; and
the communication interface configured to receive the OFDMA frame and the duplicate of the OFDMA from the processor.

3. The wireless communication device of claim 1 further comprising:
the communication interface configured to:
down-clock the OFDMA frame from a first frequency to a second frequency to generate a down-clocked OFDMA frame, wherein the first sub-channel or channel and the second sub-channel or channel have a bandwidth corresponding to the second frequency; and
to generate the duplicate of the OFDMA based on the down-clocked OFDMA frame.

4. The wireless communication device of claim 1 further comprising:
the communication interface configured to transmit one or more other duplicates of the OFDMA frame via one or more other sub-channels or channels to the first and second other wireless communication devices.

5. The wireless communication device of claim 1 further comprising:
the processor configured to:
generate the OFDMA frame based on a first IEEE 802.11 communication protocol; and
generate another frame based on a second IEEE 802.11 communication protocol that is a prior IEEE 802.11 communication protocol relative to the first IEEE 802.11 communication protocol; and
the communication interface configured to transmit the other frame to at least one of the first, the second, and a third other wireless communication device.

6. The wireless communication device of claim 1 further comprising:
the processor configured to generate another OFDMA frame that includes third data for the first other wireless communication device and fourth data for the second other wireless communication device; and
the communication interface configured to transmit the other OFDMA frame via a third sub-channel or channel of the frequency band and a duplicate of the other OFDMA frame via a fourth sub-channel or channel of the frequency band to the first and second other wireless communication devices, wherein the first and second sub-channels or channels have a first bandwidth and the third and fourth sub-channels or channels have a second bandwidth.

7. The wireless communication device of claim 1, wherein the first and second sub-channels or channels of the frequency band correspond to less than an entirety of the frequency band.

8. The wireless communication device of claim 1 further comprising:
an access point (AP), wherein at least one of the first other wireless communication device and the second other wireless communication device is a wireless station (STA).

9. A wireless communication device comprising:
a communication interface configured to receive a signal via a first sub-channel or channel of a frequency band and duplicate of the signal via a second sub-channel or channel of the frequency band from another communication device; and
a processor configured to:
process the signal corresponding to generate a first orthogonal frequency division multiple access (OFDMA) frame;
process the duplicate of the signal to generate a second OFDMA frame;
extract first data within at least one of the first and second OFDMA frames mapped to one or more sub-carriers associated with the wireless communication device; and
discard second data within at least one of the first and second OFDMA frames mapped to one or more sub-carriers associated with the wireless communication device.

10. The wireless communication device of claim 9, wherein at least one of the first and second OFDMA frames is based on a first IEEE 802.11 communication protocol; and further comprising:
the communication interface configured to receive another signal that includes another frame that is a prior IEEE 802.11 communication protocol relative to the first IEEE 802.11 communication protocol.

11. The wireless communication device of claim 9 further comprising:
the communication interface configured to receive one or more other duplicates of the signal via one or more other sub-channels or channels of the frequency band from the other wireless communication device; and
the processor configured to:
process the one or more other duplicates of the signal to generate one or more other OFDMA frames; and
extract the first data and discard the second data also based on the one or more other OFDMA frames.

12. The wireless communication device of claim 9, wherein the first and second sub-channels or channels of the frequency band correspond to less than an entirety of the frequency band.

13. The wireless communication device of claim 9 further comprising:
a wireless station (STA), wherein the first other wireless communication device is an access point (AP), and the second other wireless communication device is another STA.

14. A method for execution by a wireless communication device, the method comprising:
generating an orthogonal frequency division multiple access (OFDMA) frame that includes first data for a first other wireless communication device mapped to a first one or more sub-carriers and second data for a second other wireless communication device mapped to a second one or more sub-carriers; and
via a communication interface of the communication device, transmitting the OFDMA frame via a first sub-channel or channel of a frequency band and a duplicate of the OFDMA frame via a second sub-channel or channel of the frequency band to the first and second other wireless communication devices.

15. The method of claim 14 further comprising:
operating a processor of the communication device to generate the duplicate of the OFDMA; and
operating the communication interface to receive the OFDMA frame and the duplicate of the OFDMA from the processor.

16. The method of claim 14 further comprising:
operating the communication interface of the communication device to:
down-clock the OFDMA frame from a first frequency to a second frequency to generate a down-clocked OFDMA frame, wherein the first sub-channel or channel and the second sub-channel or channel have a bandwidth corresponding to the second frequency; and
generate the duplicate of the OFDMA based on the down-clocked OFDMA frame.

17. The method of claim 14 further comprising:
via the communication interface of the communication device, transmitting one or more other duplicates of the OFDMA frame via one or more other sub-channels or channels to the first and second other wireless communication devices.

18. The method of claim 14 further comprising:
generating the OFDMA frame based on a first IEEE 802.11 communication protocol; and
generating another frame based on a second IEEE 802.11 communication protocol that is a prior IEEE 802.11 communication protocol relative to the first IEEE 802.11 communication protocol; and
operating the communication interface of the communication device to transmit the other frame to at least one of the first, the second, and a third other wireless communication device.

19. The method of claim 14 further comprising:
generating another OFDMA frame that includes third data for the first other wireless communication device and fourth data for the second other wireless communication device; and
operating the communication interface of the communication device to transmit the other OFDMA frame via a third sub-channel or channel of the frequency band and a duplicate of the other OFDMA frame via a fourth sub-channel or channel of the frequency band to the first and second other wireless communication devices, wherein the first and second sub-channels or channels have a first bandwidth and the third and fourth sub-channels or channels have a second bandwidth.

20. The method of claim 14, wherein the wireless communication device is an access point (AP), and at least one of the first other wireless communication device and the second other wireless communication device is a wireless station (STA).
